(19) United States
(12) Patent Application Publication
(10) Pub. No.: US 2026/0024867 A1
(43) Pub. Date: Jan. 22, 2026

(54) BATTERY PACK SHIELD SYSTEM WITH FLEXIBLE PASSTHROUGH

(71) Applicant: Ford Global Technologies, LLC, Dearborn, MI (US)

(72) Inventor: Mike Popovski, Canton, MI (US)

(21) Appl. No.: 18/774,341

(22) Filed: Jul. 16, 2024

(51) Int. Cl. H01M 50/296; B60K 1/04; H01M 50/204; H01M 50/249; H01M 50/298

(52) U.S. Cl. CPC H01M 50/296; B60K 1/04; H01M 50/204; H01M 50/249; H01M 50/298; B60K 2001/0438; H01M 2220/20

(57) ABSTRACT

A battery pack shield system includes a battery pack structure having an aperture, a flexible passthrough spanning the aperture, and a connection assembly that extends through the flexible passthrough and the aperture. The flexible passthrough can include a plurality of flexible strands or flexible flaps that are configured to flex to accommodate the connection assembly.

### TECHNICAL FIELD

This disclosure relates generally to a flexible passthrough that can shield area from vent byproducts expelled from one or more battery cells within a traction battery pack.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

### SUMMARY

In some aspects, the techniques described herein relate to a battery pack shield system, including: a battery pack structure having an aperture; a flexible passthrough spanning the aperture; and a connection assembly that extends through the flexible passthrough and the aperture.

In some aspects, the techniques described herein relate to a battery pack shield system, wherein the connection assembly extends through the aperture from a first side of the battery pack structure to an opposite, second side of the battery pack structure.

In some aspects, the techniques described herein relate to a battery pack shield system, wherein the connection assembly is a wiring harness.

In some aspects, the techniques described herein relate to a battery pack shield system, wherein the connection assembly is a hose assembly.

In some aspects, the techniques described herein relate to a battery pack shield system, further including a component attached to the battery pack structure, wherein the connection assembly is coupled to the component.

In some aspects, the techniques described herein relate to a battery pack shield system, wherein the connection assembly is a plugin connector that is coupled to the component.

In some aspects, the techniques described herein relate to a battery pack shield system, wherein the battery pack structure is a battery pack enclosure that houses a plurality of battery cells within an interior of the battery pack enclosure, wherein the component is at least partially disposed outside of the interior, and the flexible passthrough is disposed between the component and the interior such that the connection assembly extends through the flexible passthrough when coupled to the component.

In some aspects, the techniques described herein relate to a battery pack shield system, wherein the flexible passthrough is configured to flex outward away from the interior toward the component, and configured to resist flexing inward toward the interior and away from the component.

In some aspects, the techniques described herein relate to a battery pack shield system, wherein the battery pack structure is a battery pack enclosure that houses a plurality of battery cells.

In some aspects, the techniques described herein relate to a battery pack shield system, wherein the battery pack structure is a wall that is housed within an interior of a battery pack enclosure.

In some aspects, the techniques described herein relate to a battery pack shield system, wherein the connection assembly extends through the aperture from a first side of the flexible passthrough to an opposite, second side of the flexible passthrough.

In some aspects, the techniques described herein relate to a battery pack shield system, wherein the flexible passthrough includes a plurality of flexible strands.

In some aspects, the techniques described herein relate to a battery pack shield system, wherein the plurality of flexible strands are configured to flex to accommodate the connection assembly.

In some aspects, the techniques described herein relate to a battery pack shield system, wherein the plurality of flexible strands directly contact the connection assembly.

In some aspects, the techniques described herein relate to a battery pack shield system, wherein the flexible passthrough is a brush plate that is connected directly to the battery pack structure.

In some aspects, the techniques described herein relate to a battery pack shield system, wherein flexible passthrough includes a one or more flexible flaps.

In some aspects, the techniques described herein relate to a battery pack shield system, wherein the one or more flexible flaps are configured to flex to accommodate the connection assembly.

In some aspects, the techniques described herein relate to a battery pack shield system, wherein the one or more flexible flaps directly contact the connection assembly.

In some aspects, the techniques described herein relate to a battery pack shield system, including: a battery pack enclosure housing a plurality of battery cells within an interior, the battery pack enclosure having at least one aperture; a flexible passthrough; and a battery assembly that extends from the interior through the flexible passthrough, the flexible passthrough including at least one flexible member that flexes to accommodate the battery assembly.

In some aspects, the techniques described herein relate to a battery pack shield system, further including a component that is at least partially outside the interior, the battery assembly operably coupled to the component.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electric vehicle having a traction battery pack.

FIG. 2 illustrates a perspective, partially expanded view of the traction battery pack from FIG. 1 with selected components shown in schematic form.

FIG. 3 illustrates a close-up view of an area of the traction battery pack showing a component expanded away from an enclosure of the traction battery pack and the connection assembly extending through a flexible passthrough of a battery pack shield system according to an exemplary aspect of the present disclosure.

FIG. 4 illustrates the connection assembly of FIG. 3 extending through the flexible passthrough of the battery pack according to another exemplary embodiment of the present disclosure.

FIG. 5 illustrates a connection assembly according to another exemplary embodiment of the present disclosure extending through the flexible passthrough of the battery pack.

### DETAILED DESCRIPTION

This disclosure relates generally to a traction battery pack of an electrified vehicle, and in particular, to a flexible passthrough. A connection assembly of the battery pack can extend from an interior of the battery pack, through the flexible passthrough, to an area outside the battery pack. The flexible passthrough flexes to accommodate the connection assembly. The flexible passthrough fills gaps near the connection assembly to block movement vent byproducts, particularly particulates.

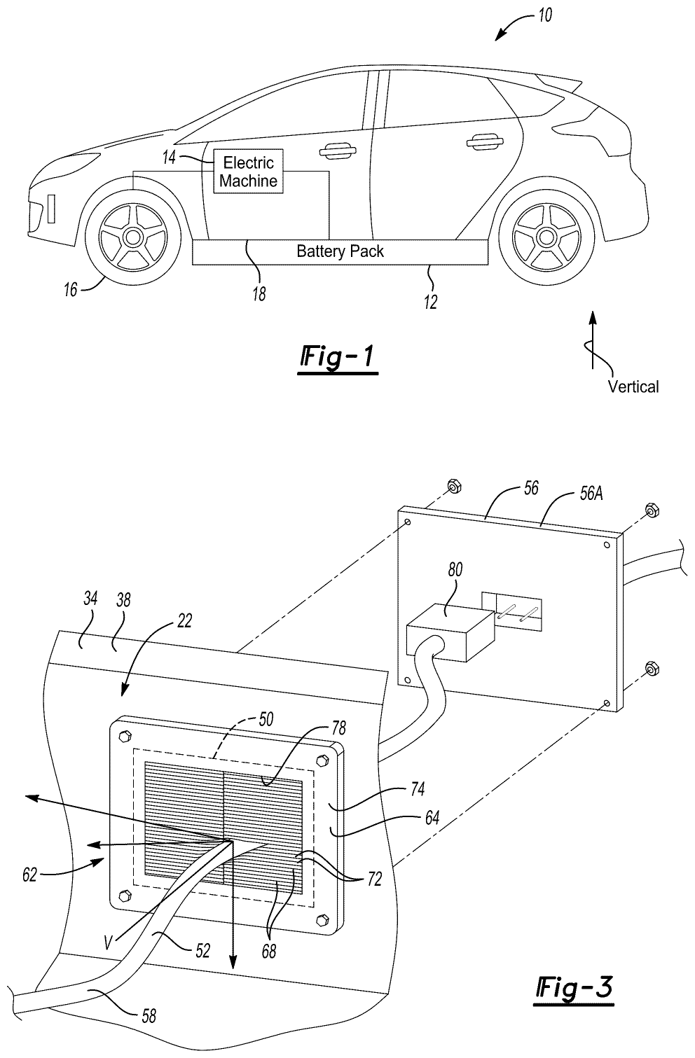

With reference to FIG. 1, an electrified vehicle 10 includes a traction battery pack 12, an electric machine 14, and wheels 16. The battery pack 12 powers the electric machine 14, which converts electric power to torque to drive the wheels 16. The battery pack 12 is a traction battery pack as the battery pack 12 is used for electric propulsion.

The battery pack 12 is, in the exemplary embodiment, secured to an underbody 18 of the electrified vehicle 10 beneath and outside a passenger compartment of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. A hybrid electric vehicle selectively drives wheels using torque provided by an internal combustion engine instead of, or in addition to, an electric machine. Generally, the electrified vehicle 10 could be any type of vehicle having a traction battery pack.

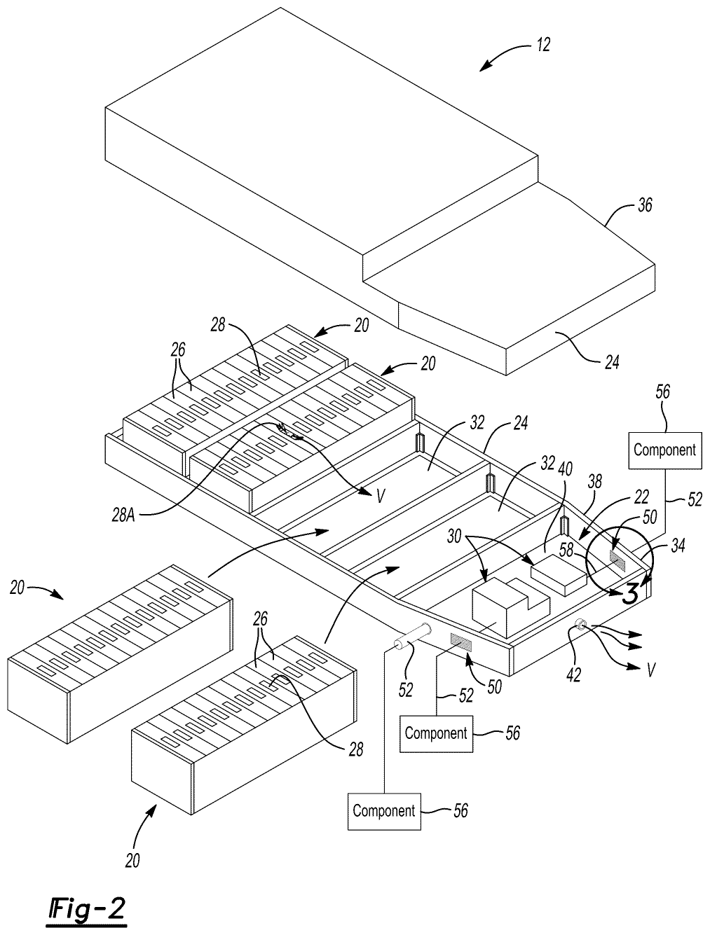

Referring now to FIG. 2 with continuing reference to FIG. 1, the battery pack 12 includes a plurality of battery arrays 20 housed within an interior 22 of an enclosure 24. The battery arrays 20 each include groups of individual battery cells 26 arranged in a rows. In an embodiment, the battery cells 26 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery cells 26 each include a vent 28. From time to time, a thermal propagation event due to, for example, an overcharge or discharge, may increase pressure and temperature in one of the battery cells 26. Thermal propagation events could also be due to internal contamination, battery cell deformation, or electrical shorts. The increasing pressure and temperature can rupture the vent 28 of the battery cell 26 and release vent byproducts V from an interior of the battery cell 26 into the interior 22. FIG. 2 shows the vent 28A of one of the battery cells 26 ruptured and releasing vent byproducts. However, more than one of the battery cells 26 can release vent byproducts V at the same time.

Some battery cells 26, such as pouch cells, may not include a discrete vent, but could rupture in various areas due to a thermal propagation event. The rupture provides an aperture that is considered a vent. Vent byproducts V discharged through an aperture created by a rupture are, for purpose of this disclosure, also considered vent byproducts V.

In this example, the enclosure 24 additionally includes a plurality of modules 30 associated with, among other things, controlling, monitoring, and managing the battery pack 12. Examples of the modules 30 can include a battery energy control module (BECM), a bussed electrical center (BEC), and a DC-DC converter.

The enclosure 24 can additionally hold thermal management assemblies 32. Liquid coolant can be circulated through the battery pack 12 and, more particularly, the thermal management assemblies 32, to manage thermal energy within the battery pack 12. The thermal management assemblies 32 can be cold plates, for example.

In this example, the enclosure 24 is a battery pack structure that includes a tray 34 and a cover 36. The tray 34 includes sidewalls 38 and a floor 40. When the cover 36 is secured to the tray 34, the enclosure 24 completely encloses the arrays 20, modules 30 and thermal management assemblies 32.

In this example embodiment, a battery pack vent 42 extends through one of the sidewalls 38 of the tray 34. The battery pack vent 42 provides a path to communicates the vent byproducts V from the interior 22 of the battery pack 12 to a desired area that is outside the battery pack 12.

The example enclosure 24 include passageways from the interior 22 to an exterior of the battery pack 12. For purposes of this disclosure, such passageways can be considered connection assembly apertures 50. Various types of connection assemblies 52 can extend through the respective connection assembly apertures 50, which are not intended for communicating vent byproducts. The connection assemblies 52 operably couple components within the interior 22 of the battery pack 12 to components outside the battery pack 12. For purposes of this disclosure, the sidewalls 38 and other areas of the enclosure 24 are considered exemplary battery structures.

The connection assemblies 52 can be any assembly that extends through one of the connection assembly apertures 50 to operably couple a component, such as one of the modules 30, on one side of a battery structure to a component 56 on another side of that battery structure. The component 56 can be a component of the vehicle 10, for example.

Examples of the connection assemblies 52 include a wire harness 58 as shown in FIG. 2. Other examples can include coolant conduits, connectors, sensors, hoses, ports, wiring, connectors, etc. Still other types of connection assemblies 52 are possible and fall within the scope of this disclosure.

As can be appreciated, connection assembly apertures that are provided to accommodate the connection assemblies may provide potential paths for vent byproducts V to escape from the interior 22 of the battery pack 12. The vent byproducts V can potentially move through these areas instead of through a vent aperture provided by the battery pack vent 42.

With reference to FIG. 3, a battery pack shield system 62 can help to block flow through the connection assembly aperture 50 that provides a passageway for the wire harness 58. In the exemplary embodiment, the battery pack shield system 62 includes a flexible passthrough 64 spanning the connection assembly aperture 50. The wire harness 58, which again is a type of connection assembly 52, extends through the flexible passthrough 64 and through the connection assembly aperture 50. In particular, the wire harness 58 extends through the connection assembly aperture 50 from a first side of the sidewall 38 to an opposite, second side of the sidewall 38.

The example flexible passthrough 64 includes a plurality of flexible members 68—here flexible strands 72—held within a housing 74 having a passthrough aperture 78, which is aligned with the connection assembly aperture 50 in the sidewall 38 of the enclosure 24. The example flexible passthrough 64 can be considered a brush plate in some examples. The housing 74 of the flexible passthrough can be directly connected to the sidewall 38 within the interior 22.

The flexible strands 72 can flex to accommodate movement of the wire harness 58 through the passthrough aperture 78 and the connection assembly aperture 50

An example of the component 56 shown schematically in FIG. 2 is the component 56A shown in FIG. 3. The component 56A can be attached to an exterior side of the sidewall 38. The component 56A can be an electrical header, for example. At least some of the component 56A can be recessed within the connection assembly aperture 50.

The connection assembly 52 in FIG. 3 is a wire harness having a plugin connector 80 that can be moved through the flexible strands 72 to engage the component 56A. The flexible strands 72 are flexible enough to be displaced as the plugin connector 80 is moved into the engaged position with the component 56A.

During assembly, the plugin connector 80 of the wire harness 58 can be moved outward from the interior 22 through the flexible passthrough 64 to engage to the component 56A. The wire harness 58, when connected to the component 56A, extends through the connection assembly aperture 50 of the flexible passthrough 64 from a first side of the flexible passthrough 64 to an opposite, second side of the flexible passthrough 64.

After the plugin connector 80 engages the component 56A, at least some of the flexible strands 72 remain flexed against the wire harness 58 and in directly contact with the wire harness 58. The flexible strands 72 can contact the wire harness 58 about an entire circumferential periphery of the wire harness 58 such that the flexible passthrough 64 conforms to the profile of the wire harness 58. The flexible strands can block vent byproducts V, particularly hot gasses and particles, from moving through gaps between in the plugin connector 80, other portions of the wire harness 58, and the component 56A, The vent byproducts are instead retained within the interior 22 and can be forced through the battery pack vent 42 instead of escaping from the interior 22 through the 50 connection assembly aperture.

In this example, the flexible strands 72 are a polymer-based material that is relatively resistant to melting. The flexible strands 72 are flexible outward away from the interior 22 and inward toward the interior 22. Flexibility of the flexible strands 72 can be adjusted by altering material composition, a quantity of the strands, a size of the individual strands, or some combination of these.

In another example, the flexible strands 72 are flexible only in one direction, say outward to function as essentially a one-way valve that permits vent byproducts V to move though the connection assembly aperture 50 but blocks the vent byproducts from reentering the interior through the connection assembly aperture 50. In such an example, the flexible strands 72 are flexible outward away from the interior 22 and are configured to resist flexing back toward the interior 22.

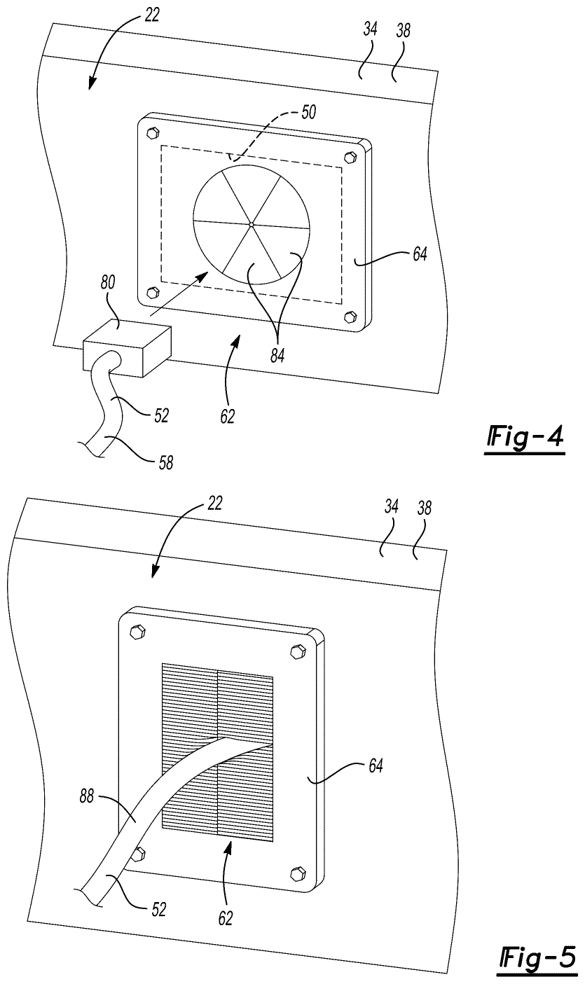

In another example, as shown in FIG. 4, a flexible passthrough 64A could include one or more flexible flaps 84 rather than the flexible strands 72. The flexible flaps 84 flex to accommodate movement of the connection assembly 52 through the connection assembly aperture 50. The flexible flaps 84 can be triangular as shown or have another profile. The flexible flaps 84, like the flexible strands 72 of a previously described example, block movement of vent byproducts V through areas about the connection assembly 52.

With reference to FIG. 5, in another example, the connection assembly 52 that extends through the flexible passthrough 64 is a hose assembly 88, which could be used to circulate coolant, for example, to or from the interior 22.

While the example embodiments of FIGS. 3 to 5 show one connection assembly extending through the flexible passthroughs 64, 64A more than one connection assembly could extend through the same flexible passthrough 64, 64A. For example, a cable bundle could extend through one area of the flexible passthrough 64 and a plugin connector could extend through another area of the same flexible passthrough 64.

Further, while the flexible passthroughs 64, 64A of the FIGS. 3 to 5 embodiments are shown as being used to block flow of vent byproducts V from the interior 22 to areas outside the interior, the flexible passthrough 64, 64A could be used to block flow of vent byproducts V from one area of the interior 22 to another area of the interior 22. For example, a wall housed within the interior 22 could be used to separate a first region of the interior 22 from a second region of the interior 22. A connection assembly needed to extend through that wall could also extend though a flexible passthrough to blocks at least some vent byproducts V emitted from a battery cells 26 in the first region from flowing into the second region of the interior 22.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack shield system, comprising:
a battery pack structure having an aperture;
a flexible passthrough spanning the aperture; and
a connection assembly that extends through the flexible passthrough and the aperture.

2. The battery pack shield system of claim 1, wherein the connection assembly extends through the aperture from a first side of the battery pack structure to an opposite, second side of the battery pack structure.

3. The battery pack shield system of claim 1, wherein the connection assembly is a wiring harness.

4. The battery pack shield system of claim 1, wherein the connection assembly is a hose assembly.

5. The battery pack shield system of claim 1, further comprising a component attached to the battery pack structure, wherein the connection assembly is coupled to the component.

6. The battery pack shield system of claim 5, wherein the connection assembly is a plugin connector that is coupled to the component.

7. The battery pack shield system of claim 5, wherein the battery pack structure is a battery pack enclosure that houses a plurality of battery cells within an interior of the battery pack enclosure, wherein the component is at least partially disposed outside of the interior, and the flexible passthrough is disposed between the component and the interior such that the connection assembly extends through the flexible passthrough when coupled to the component.

8. The battery pack shield system of claim 7, wherein the flexible passthrough is configured to flex outward away from the interior toward the component, and configured to resist flexing inward toward the interior and away from the component.

9. The battery pack shield system of claim 1, wherein the battery pack structure is a battery pack enclosure that houses a plurality of battery cells.

10. The battery pack shield system of claim 1, wherein the battery pack structure is a wall that is housed within an interior of a battery pack enclosure.

11. The battery pack shield system of claim 1, wherein the connection assembly extends through the aperture from a first side of the flexible passthrough to an opposite, second side of the flexible passthrough.

12. The battery pack shield system of claim 1, wherein the flexible passthrough includes a plurality of flexible strands.

13. The battery pack shield system of claim 12, wherein the plurality of flexible strands are configured to flex to accommodate the connection assembly.

14. The battery pack shield system of claim 13, wherein the plurality of flexible strands directly contact the connection assembly.

15. The battery pack shield system of claim 12, wherein the flexible passthrough is a brush plate that is connected directly to the battery pack structure.

16. The battery pack shield system of claim 1, wherein flexible passthrough includes a one or more flexible flaps.

17. The battery pack shield system of claim 16, wherein the one or more flexible flaps are configured to flex to accommodate the connection assembly.

18. The battery pack shield system of claim 17, wherein the one or more flexible flaps directly contact the connection assembly.

19. A battery pack shield system, comprising:
a battery pack enclosure housing a plurality of battery cells within an interior, the battery pack enclosure having at least one aperture;
a flexible passthrough; and
a battery assembly that extends from the interior through the flexible passthrough, the flexible passthrough including at least one flexible member that flexes to accommodate the battery assembly.

20. The battery pack shield system of claim 19, further comprising a component that is at least partially outside the interior, the battery assembly operably coupled to the component.
